(19) United States
(12) Patent Application Publication
(10) Pub. No.: US 2024/0090728 A1
(43) Pub. Date: Mar. 21, 2024

(54) VACUUM CLEANER BATTERY UNIT

(71) Applicant: Dyson Technology Limited, Wiltshire (GB)

(72) Inventors: Edward Richard OLDFIELD, Swindon (GB); Peter James NEWELL, Gloucester (GB); Christopher John BATEMAN, Swindon (GB); Sergio MINGUELA SANCHEZ, Bristol (GB)

(73) Assignee: Dyson Technology Limited, Wiltshire (GB)

(21) Appl. No.: 18/273,505

(22) PCT Filed: Dec. 14, 2021
(86) PCT No.: PCT/GB2021/053272

§ 371 Date: Jul. 20, 2023

(30) Foreign Application Priority Data
Jan. 22, 2021 (GB) 2100848.7

(51) Int. Cl. A47L 9/28; A46B 13/00; A46B 13/02; A47L 9/00; A47L 9/04; H01M 10/42; H01M 10/48; H01M 50/204; H01M 50/247; H01M 50/256; H01M 50/258; H01M 50/51

(52) U.S. Cl. CPC A47L 9/2884; A46B 13/001; A46B 13/02; A47L 9/009; A47L 9/0477; A47L 9/2889; H01M 10/425; H01M 10/482; H01M 10/486; H01M 50/204; H01M 50/247; H01M 50/256; H01M 50/258; H01M 50/51; A46B 2200/3033; H01M 2010/4271; H01M 2010/4278; H01M 2200/10; H01M 2220/30

(57) ABSTRACT

A vacuum cleaner with a battery unit for powering the vacuum cleaner is provided. The battery unit includes a plurality of serially connected battery cells and battery management electronics operatively coupled to the battery cells. Two enclosures are provided on either side of a central axis of the vacuum cleaner, each enclosure including a portion of the plurality of battery cells, and a portion of the battery management electronics operatively coupled to the respective portion of the plurality of the battery cells. A link strap interconnects the portions of the battery management electronics.

### TECHNICAL FIELD

The present invention relates to a vacuum cleaner for cleaning a surface, the vacuum cleaner comprising a battery unit for powering the vacuum cleaner, the battery unit comprising a plurality of serially connected battery cells and battery management electronics, operatively coupled to the battery cells.

### BACKGROUND

Vacuum cleaners are devices that suction air containing dust by using suction force generated by a suction motor mounted in a main body of the vacuum cleaner. Traditionally, vacuum cleaners comprise a long extendable power chord that is plugged into a wall socket for powering the suction motor. Long power chords may get entangled during use and can lead to damaged furniture, falling objects and tripping users. Short power chords reduce the user's freedom of movement and frequently need to be plugged into new power sockets that may not be freely available close to where the vacuum cleaning takes place.

To avoid such practical problems, modern vacuum cleaners, both of the manual and of the autonomous variety, are often cordless and powered by batteries. After a cleaning job, a battery unit comprising the batteries can be charged at a docking station or by plugging the vacuum cleaner into a wall socket. A vacuum cleaner battery unit generally comprises one or more battery packs filled with a collection of Li-ion battery cells and some battery electronics for controlling the charging and discharging of the battery unit.

For example, EP 3 354 177 A1 discloses a vacuum cleaner with a main body comprising the suction motor, a battery unit and a dust container. A wand with a cleaner head is connected to the dust bin via a hose. The main body rolls over the floor while the user moves the wand around to let the cleaner head remove the dirt from the floor. The battery unit comprises two battery packs that are together mounted on a mounting part at the right rear edge of the main body. A switching mechanism is provided for connecting the two battery packs in parallel or in series.

Battery powered vacuum cleaners are also provided as handheld vacuum cleaners, stick vacuum cleaners and autonomous (i.e. robot) vacuum cleaners. Handheld and stick vacuum cleaners are held by the user during use and are therefore designed to be relatively compact and lightweight compared to vacuum cleaners that have their main bodies rolling over the floor during use. Robot vacuum cleaners need to be compact and lightweight in order to be able to reach all small corners of the rooms to be cleaned and to move around in an energy efficient way.

Battery packs generally have a higher mass density than most other parts of the vacuum cleaner, such as a main body housing, wheels, a cleaner head, a main vacuum motor, dust filters, electronics, and a dust bin or dust bag, which are typically made of more lightweight materials such as plastic. If not centrally placed in the vacuum cleaner, the heavy battery unit may lead to weight imbalances. Such imbalances may make it more difficult or uncomfortable to move the vacuum cleaner around during use. A possible solution to that problem is to counter balance the battery unit by other entities, but this leads to further restrictions on the vacuum cleaner design and/or may add to the overall weight of the device.

It is an aim of the present invention to address one or more disadvantages associated with the prior art.

### SUMMARY OF THE INVENTION

According to an aspect of the invention there is provided a vacuum cleaner for cleaning a surface. The vacuum cleaner comprises a battery unit for powering the vacuum cleaner. The battery unit comprises a plurality of serially connected battery cells and battery management electronics operatively coupled to the battery cells. The battery unit further comprises two enclosures provided on either side of a central axis of the vacuum cleaner. Each enclosure comprises a portion of the plurality of battery cells, and a portion of the battery management electronics operatively coupled to the respective portion of the plurality of the battery cells. The battery unit further comprises a link strap, interconnecting the portions of the battery management electronics.

Splitting the battery unit into separate enclosures that can be freely positioned at any appropriate position in the vacuum cleaner, allows the design engineer to better balance the weight distribution in such a way to allow easy handling of the vacuum cleaner. It is an important aspect of the invention, that the battery cells in the two enclosures together form one battery unit with a plurality of serially connected battery cells. No load sharing electronics are needed for balancing the load of separate battery packs that are connected in parallel, making it easier to ensure that all battery cells are kept at a similar state of charge. This may increase the available time of operation between two charging events. A further advantage of the series connection between the battery cells in different enclosures is that the ageing process of the battery cells will be better balanced, thereby making the battery unit as a whole function more satisfactory over a longer period of time.

Preferably, the battery management electronics are configured to supply power and convey data through the link strap. The link strap may be a cable loom comprising multiple cables. Some cables may be used for the series connection between a battery cell in the first enclosure and a battery cell in the second enclosure, and other cables may be used for exchanging data between the battery management electronics portions in the two enclosures.

A further advantage provided by the invention is that dividing of the battery management electronics over the two enclosures makes it possible for the battery cells in the different enclosures to share common battery management electronics that can be safely and efficiently operated from across the link strap. At the same time some more essential battery management control electronics can be provided in both enclosures and kept at or close to the location of the battery cells. For example, each portion of the battery management electronics comprises at least one temperature sensor for measuring a temperature of at least one of the battery cells in the respective enclosure. Temperature sensing needs to take place at the battery cells and cannot be done by sensor electronics located in another enclosure. Preferably, each portion of the battery management electronics further comprises a thermal protection circuit, operatively coupled to the at least one temperature sensor and configured to prevent overheating of at least one of the battery cells. This enables the thermal protection circuit to continue working when, e.g., the link strap is mechanically damaged and temperatures in one of the enclosures rapidly increase due to short circuits caused by that damage. Other useful electronic features to include in each enclosure are fuses or a charger connection detection circuit.

In an embodiment of the invention, the portion of the battery management electronics in a first one of the two enclosures is part of a master module and the portion of the battery management electronics in a second one of the two enclosures is part of a slave module and wherein only the master module comprises a data connector for enabling a direct data connection to a vacuum cleaner control unit that is not part of the battery unit. For example, the battery management electronics on the slave module may be mainly restricted to lower level direct control of battery cells, while the shared higher level control electronics is provided at the master module. Data can be transmitted between the master and slave modules through data wires running through the link strap. This allows higher level control electronics at the master module to take into account data, such as temperature data or charging state data of individual battery cells, generated at both modules and to instruct the slave module to control the battery cells in its respective enclosure to operate according to a centrally determined control strategy. Only the higher level battery control electronics in the master module use a data connection to a general vacuum cleaner control unit that is installed elsewhere in the vacuum cleaner. It is noted that ‘direct data connection’ here means through one or more data wires that only transfer, but not process the communicated data.

In an embodiment of the invention, the two enclosures are provided substantially symmetrically on either side of the central axis. A symmetric layout of the two battery cell enclosures leads to a better weight balance and easier handling of the vacuum cleaner. However, if the vacuum cleaner itself is not very symmetric or a weight balance of other vacuum cleaner parts is uneven, it may be advantageous to depart from a substantially symmetric layout of the enclosures. It is noted that in most vacuum cleaners a central axis may be drawn in many different orientations. The main characteristic feature of a central axis is that it runs through a geometric centre of the device. Balancing the device weight by distributing the battery unit weight over both sides of any such central axis brings the advantage of easily achieving an improved overall weight distribution for the vacuum cleaner, thereby improving its stability.

Preferably, the two enclosures are provided substantially symmetrically on either side of a central axis that runs parallel to the general direction of movement during use. This will ensure that the centre of mass of the vacuum cleaner is positioned on or close to the central axis and that the vacuum cleaner will remain stable during use. In addition thereto, it may be advantageous to have the centre of mass positioned somewhat rearward of the geometric centre of the vacuum cleaner, wherein ‘rearward’ is defined in relation to the general forward direction of movement during use. Such location helps to improve traction of the driving wheels or tracks and makes it easier for the vacuum cleaner to move over lower obstacles.

The two enclosures may comprise an equal number of the battery cells. In a symmetric setup, this may help to provide an even weight distribution and a centre of mass that is located near the geometric centre of the vacuum cleaner. When both enclosures comprise different numbers of battery cells, the enclosures may be installed slightly asymmetrical on either side of the central axis to compensate for the resulting weight difference. Alternatively or additionally, the difference in weight may be compensated by strategically arranging other functional components of the vacuum cleaner.

The two enclosures may comprise battery cells of the same type. ‘The same type’ herein means that the battery cells at least have the same battery capacity (Ah), but ‘type’ may further relate to the brand, model and version of the battery cells. In addition thereto, the battery cells may even have been manufactured in the same factory and on the same day or hour. Battery cells from the same type, or even from the same production batch, share the same or very similar charging, discharging and ageing characteristics. Where such characteristics are influenced by external factors such as temperature, also their dependence on the external factors will be similar to all battery cells.

In special embodiments, the battery unit may comprise more than two enclosures, each enclosure comprising a portion of the plurality of battery cells and a portion of the battery management electronics operatively coupled to the portion of the plurality of the battery cells, the battery unit further comprising at least one additional link strap interconnecting the portions of the battery management electronics comprised in two of the more than two enclosures. The use of three or more enclosures for the battery cells may be advantageous for achieving an even more balanced weight distribution, possibly in all three dimensions. Further, design constraints may make it difficult to find large areas in the vacuum cleaner design that can be used for containing many battery cells. Instead, a larger number of smaller enclosures with fewer battery cells may be easier to integrate into the overall product design.

In an embodiment of the invention, the vacuum cleaner is an autonomous robotic vacuum cleaner. The usually very compact design of such robotic vacuum cleaners results in additional challenges for integrating the battery cells into the device. For efficiently and accurately driving and steering the robotic vacuum cleaner through the rooms it has to clean, it is preferred that its centre of mass is on or close to the central axis of the device, where possible close to a central point between the wheels supporting the robotic vacuum cleaner on the ground. When, like in some prior art robotic vacuum cleaners, the battery unit consists of a single enclosure filled with battery cells, this will only be possible if the battery unit is placed at the centre of the device. Such an arrangement leaves little room for other functional elements such as a vacuum motor, dust filters and other types of dirt separators, and a dust bin. When, according to the invention, dividing the battery cells over two or more enclosures, the battery cells can be placed closer to the periphery of the device, while keeping the centre of mass of the device close to or in line with its geometric centre.

The robotic vacuum cleaner may further comprise a rotatable brush bar for agitating the floor surface, wherein the central axis of the vacuum cleaner is defined as a line crossing a geometric centre of the brush bar and of the vacuum cleaner. That central axis is parallel to the general forward (or backward) direction of movement during use and generally perpendicular to the longitudinal axis of the brush bar.

Preferably, the vacuum cleaner comprises at least three support members for supporting the vacuum cleaner on a floor surface, and the enclosures are positioned in such a way that a centre of mass of the vacuum cleaner is located in a central position between the support members. ‘Central position’, here, is to be interpreted as its horizontal position being at or close to the midpoint of the at least three support members. It is likely that the vertical position of the centre of mass will be above the support members. Preferably, the centre of mass is positioned rearward of the geometric centre of the vacuum cleaner, wherein ‘rearward’ is defined in relation to the general forward direction of movement during use. A slightly rearward position of the centre of gravity helps to improve traction of the driving wheels or tracks and makes it easier for the vacuum cleaner to move over lower obstacles.

The support members will typically be wheels. Some or all wheels may be driven and/or steerable. Other wheels may just follow the movement of the vacuum cleaner. Such follower wheels may either be caster wheels or one-directional wheels with a fixed axle.

In an embodiment of the invention, one of the enclosures further comprises an exhaust for releasing cleaned air from a main working airflow of the vacuum cleaner. Especially in robotic vacuum cleaners with limited space available to pack all the functional components, this may be a practical way to position the battery cell enclosures at the periphery of the device, while still providing an efficient main working airflow path

### BRIEF DESCRIPTION OF THE DRAWINGS

Embodiments of the invention will now be described by way of example with reference to the accompanying drawings, in which:

FIG. 1 shows a perspective view of an autonomous robotic vacuum cleaner according to the invention.

FIG. 2 shows the autonomous robotic vacuum cleaner of FIG. 1, with its battery unit removed.

FIG. 3 shows a horizontal cross-section of part of the battery unit of FIG. 2.

FIG. 4 shows a perspective view of the same part of the battery unit as shown in FIG. 3.

FIG. 5 shows a side view of the battery pack shown in FIG. 4.

FIGS. 6a and 6b show details of the link strap of the battery unit of FIG. 2.

FIG. 7 shows an electrical diagram of a possible way to electrically connect the battery cells in the battery unit of FIG. 2.

### DETAILED DESCRIPTION

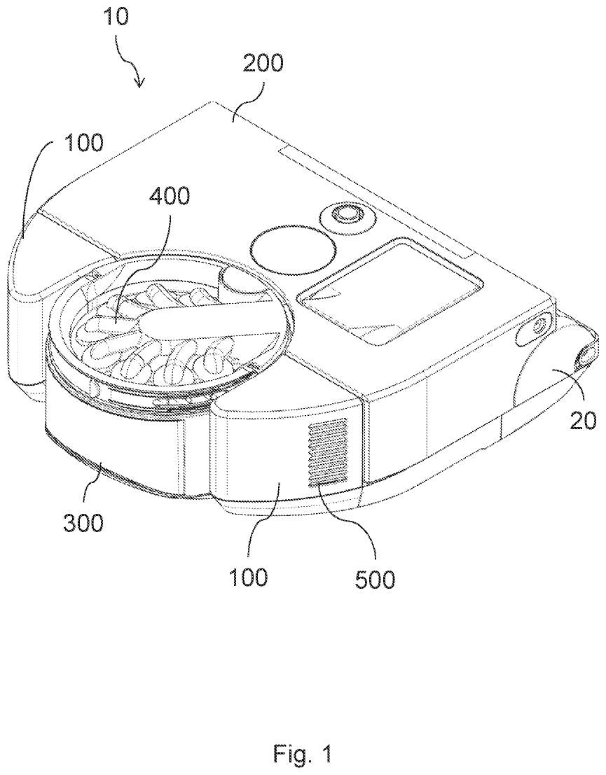

FIG. 1 shows a perspective view of an autonomous robotic vacuum cleaner 10 according to the invention. It is noted that the autonomous robotic vacuum cleaner 10 is just one example of an embodiment of the invention. The inventive arrangement of the battery unit 10 is equally applicable and useful in other robotic and non-robotic vacuum cleaners, e.g. in all types of hand-held vacuum cleaners, in which a well-balanced weight distribution makes it easier to use the vacuum cleaner.

Inside the vacuum cleaner 10, there is an electric motor (not shown) that draws in dirty air from the surface being cleaned and pulls it through one or more dirt separating stages before the clean air is released into the vacuum cleaner's immediate surroundings through an exhaust 500. In the embodiment shown here, the main dirt separating stage is formed by a cyclonic particle separator 400 that uses a whirling airstream and gravity to get the dirt out of the air flow. After the cyclonic particle separator 400, the airflow passes a motor pre-filter, the motor and a motor post-filter, to finally leave the vacuum cleaner 10 at the exhaust 500. The separated dirt is collected in a dust bin 300 that may be emptied when full or whenever the user decides to do so. An agitator in the form of a cylindrical brush bar 20 is mounted at the dirty air inlet of the vacuum cleaner 10. The brush bar 20 is intended primarily to improve “pick up” on carpeted surfaces. In use, bristles on the brush bar 20 reach through the air inlet to penetrate the carpet fibres, and the agitating action of the brush bar 20 as it rotates helps dislodge stubborn dirt clinging to the carpet fibres.

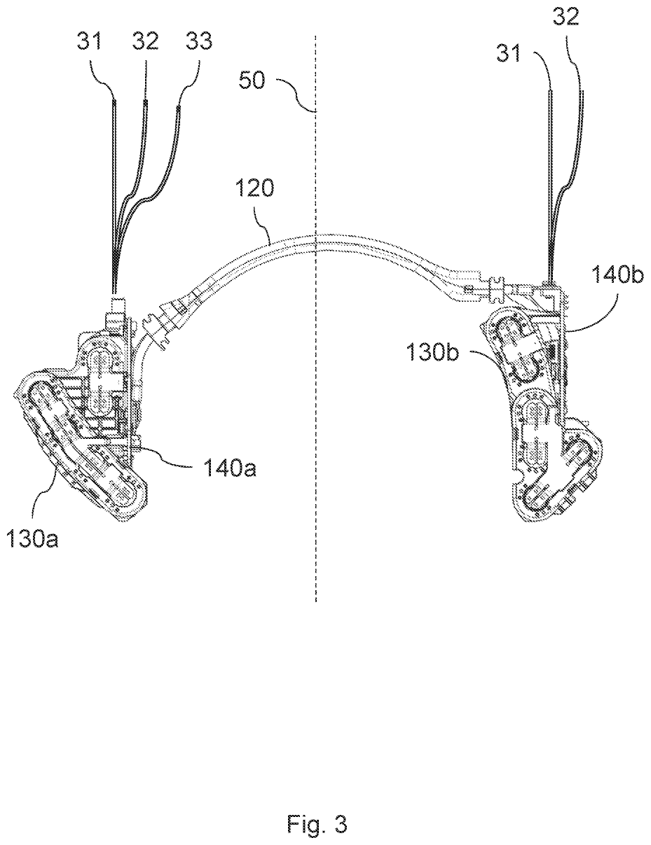

The motor of the vacuum cleaner 10 is powered by a battery unit 100 that will be described in more detail with reference to the following figures. In addition to the main vacuum motor, also other parts like driven wheels or tracks, some control electronics or a brush bar motor may be powered by the battery unit 100. In accordance with the invention, the battery unit 100 is substantially symmetrically distributed over a left and right side of the vacuum cleaner 10, the left and right side of the vacuum cleaner 10 being defined by a central axis 50 (see FIG. 3) or central vertical plane 50 that extends through the centres of the vacuum cleaner 10 and the brush bar 20. In this embodiment, also the dust bin 300 and the cyclonic particle separator 400 are provided centrally in the device 10. In the vacuum cleaner 10 of FIG. 1, the battery unit 100 is wrapped around the dust bin 300 and cyclonic particle separator 400.

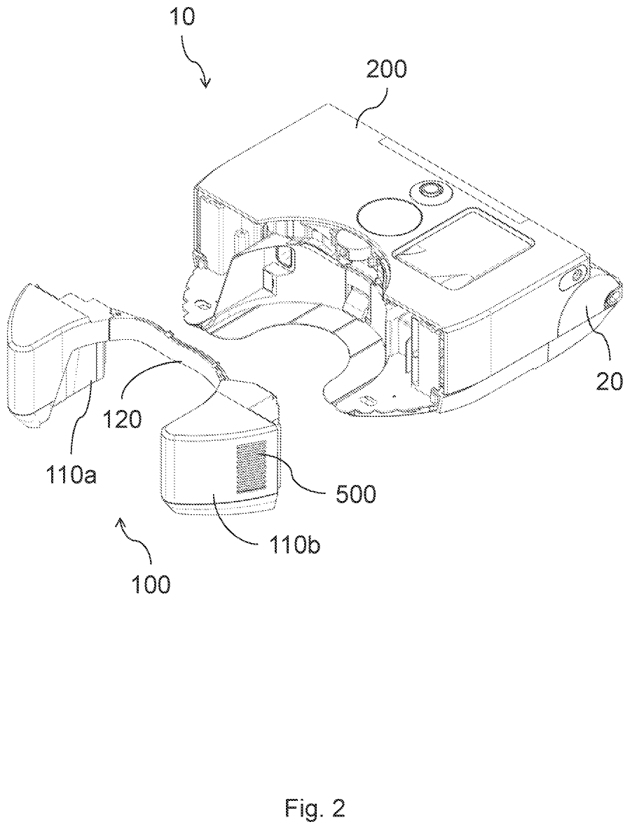

FIG. 2 shows the autonomous robotic vacuum cleaner 10 of FIG. 1, with its battery unit 100 removed. The battery unit 100 is shaped to wrap around the dust bin 300 and cyclonic particle separator 400. In this embodiment, the dust bin 300 and cyclonic particle separator 400 have to be removed first before removal of the battery unit 100 is possible, but the various parts of the vacuum cleaner 10 may be arranged differently in other embodiments. The battery unit 100 comprises two enclosures 110a, 110b, linked by a link strap 120. The two enclosures 110a, 110b are provided at the left and right side of a gap large enough to contain the dust bin 300 and the cyclonic particle separator 400. As will be shown in the following figures, each enclosure 110a, 110b comprises a portion of the battery cells and of the battery management electronics of the battery unit 100. The link strap 120 interconnects the two enclosures 110a, 110b both mechanically and electrically.

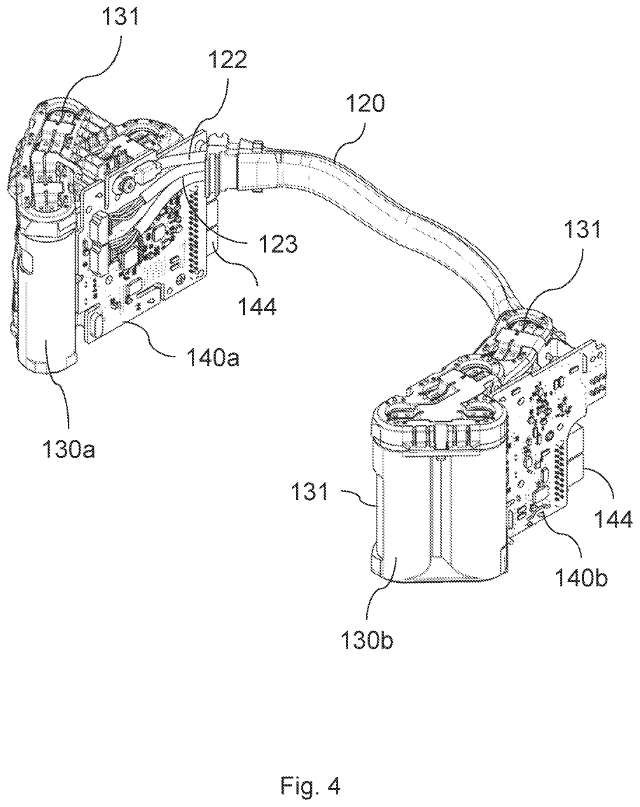

FIG. 3 shows a horizontal cross-section of part of the battery unit 100 of FIG. 2. FIG. 4 shows a perspective view of the same. In both figures, the battery unit 100 is shown with the enclosure covers removed. As can be seen in these figures, each enclosure 110 comprises a battery pack 130a, 130b with a number of battery cells 131, six in this example. In addition to the battery cells 131, each enclosure 110a, 110b comprises a portion of the battery management electronics 140a, 140b. For an optimal weight balance, it is advantageous to have the same number of battery cells 131 in each enclosure 110a, 110b. However, when the battery unit 100 is not installed fully symmetrically, or if the weight of other parts of the vacuum cleaner 10 is not evenly distributed over both sides, it may be better to use different numbers of cells in the two enclosures 110a, 110b. In this particular embodiment, the two battery packs 130a, 130b are differently shaped in order to conform to design of the enclosures 110a, 110b and to optimize the integration into the vacuum cleaner design as a whole. The battery pack 130b on the right side of the figures is shaped to provide room for the exhaust channel 500 that is included in the same enclosure 110b.

It is to be noted that the battery cells 131 inside an enclosure 110 are not necessarily contained in a single unit or package, as they are in this embodiment. Alternatively, the enclosure housing itself may function as a casing for the battery cells 131. At its inside surfaces, the enclosure housing may comprise some alignment structures for keeping the battery cells 131 in position or for physically separating them from each other and/or from the battery management electronics 140a, 140b.

Preferably, the two battery packs 110a, 110b comprise battery cells 131 of the same type. ‘The same type’ herein means that the battery cells 131 at least have the same battery capacity (Ah), but ‘type’ may further relate to the brand, model and version of the battery cells 131. In addition thereto, the battery cells 131 may even have been manufactured in the same factory and on the same day or hour. Battery cells 131 from the same type, or even from the same production batch, share the same or very similar charging, discharging and ageing characteristics. Where such characteristics are influenced by external factors such as temperature, also their dependence on the external factors will be similar to all battery cells 131. It is noted that in the here described embodiment, the nearby warm exhaust air coming from the main vacuum motor may have a slight temperature increasing effect on the right hand battery pack 130b. This effect may be partially or fully compensated for dividing the battery management electronics 140a, 140b over the two enclosures in such a way that more heat is generated by the electronics portion 140a in the left enclosure 110a than by the electronics portion 140b in the right enclosure 110b.

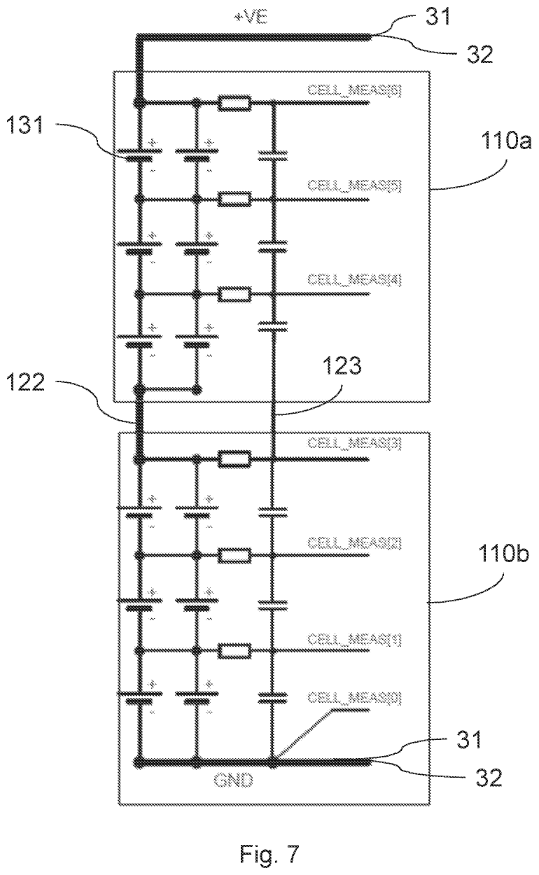

As will be discussed in more detail below with reference to FIG. 7, the battery cells 131 of the two battery packs 130a, 130b are connected in series, thereby effectively forming a single battery unit 100, controlled by the combined battery management electronics 140a, 140b in the two enclosures 110a, 110b. The components of the battery management electronics 140a, 140b are provided on two electronic circuit boards, one in each enclosure 110a, 110b. A link strap 120 includes two data cables 123 for enabling data communication between the right and left portions of the battery management electronics 140a, 140b. In other embodiments, more or fewer data cables 123 may be comprised in the link strap 120.

The link strap 120 further comprises a power cable 122 that provides for an electrical connection between a battery cell 131 in the left enclosure 110a and a battery cell 131 in the right enclosure 110b. Preferably, as in this embodiment, the power cable 122 is connected to the battery cells 131 via the circuit boards. Alternatively, the power cable 122 may be directly connected to a terminal of one of the battery cells 131 in each enclosure 110a, 110b.

Each circuit board comprises one or more connectors 144 for connecting the battery cells 131 and the battery management electronics 140a, 140b to parts outside the battery unit 100, such a charger for charging the battery cells, the vacuum main body 200, a vacuum motor and other parts powered by the battery unit 100, or a main controller of the vacuum cleaner 10. When the battery cells 131 are being charged, charging current runs from the charger through a charging cable 31 to a connector 144 at one of the enclosures 110a, 110b. Then through the circuit board to which the connector 144 is attached, the power cable 122, the circuit board at the other end of the link strap 120, the connector 144 attached thereto and finally through the other charging cable 31 back to the charger. A similar discharging loop includes two discharging cables 32 connecting each portion of battery cells 131 to the battery powered vacuum cleaner parts.

By dividing the battery management electronics 140a, 140b over the two enclosures 110a, 110b it is made possible for the battery cells 131 in the different enclosures 110a, 110b to share common battery management electronics 140a, 140b that can be safely and efficiently operated from across the link strap 120. At the same time some more essential battery management control electronics 140a, 140b can be provided in both enclosures 110a, 110b and kept at or close to the location of the battery cells 131. For example, each portion of the battery management electronics 140a, 140b comprises at least one temperature sensor 141 for measuring a temperature of at least one of the battery cells 131 in the respective enclosure 110a, 110b. Temperature sensing needs to take place at the battery cells 131 and cannot be done by sensor electronics located in the other enclosure 110a, 110b. Preferably, each portion of the battery management electronics 140a, 140b further comprises a thermal protection circuit, operatively coupled to the at least one temperature sensor and configured to prevent overheating of at least one of the battery cells 131. This enables the thermal protection circuit to continue working when, e.g., the link strap 120 is mechanically damaged and temperatures in one of the enclosures 110a, 110b rapidly increase due to short circuits caused by that damage. Other useful electronic features to include in each enclosure 110a, 110b are fuses or a charger connection detection circuit.

In this embodiment, the battery management electronics are divided over a master module 140a in the left enclosure 110a and a slave module 140b in the right enclosure 110b. Only the master module 140a comprises a data connector 144 for enabling a direct data connection to a vacuum cleaner control unit that is not part of the battery unit 100. For example, the slave module 140b may be mainly restricted to lower level direct control of battery cells 131, such as the thermal protection described above, while the shared higher level control electronics is provided at the master module 140a. Data can be transmitted between the master and slave modules 140a, 140b through data wires 123 running through the link strap 120. This allows higher level control electronics at the master module 140a to take into account data, such as temperature data or charging state data of individual battery cells, generated at both modules 140a, 140b and to instruct the slave module 140b to control the battery cells 131 in its respective enclosure 110b to operate according to a centrally determined control strategy. Only the higher level battery control electronics in the master module 140a use a data connection to a general vacuum cleaner control unit that is installed elsewhere in the vacuum cleaner 10. Sharing the higher level battery control electronics means that such functionality does not, like in the prior art, have to be provided in both enclosures 110a, 110b. In addition thereto, the master-slave setup avoids the need for adding even more control electronics, outside the two enclosures 110a, 110b, for aligning the operation of two independent and separate battery packs.

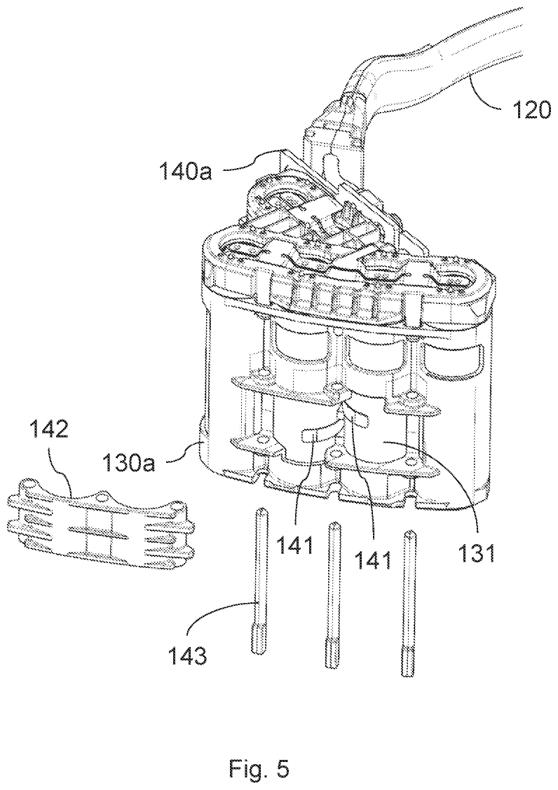

FIG. 5 shows a side view of one of the battery packs 130a of the same embodiment. In addition to what has already been described above, this view shows two temperature sensors 141 making contact with an outer surface of two of the battery cells 131. The temperature sensors 141 may, e.g., be TFT sensors that, with their other end, are connected to the circuit board in the respective enclosure 110a. A cover 142 may be used to close off the battery pack 130a after correctly installing the temperature sensors 141. The cover is held in place by three pins 143 and may help to keep the temperature sensors 141 firmly in place, thereby ensuring accurate temperature measurements.

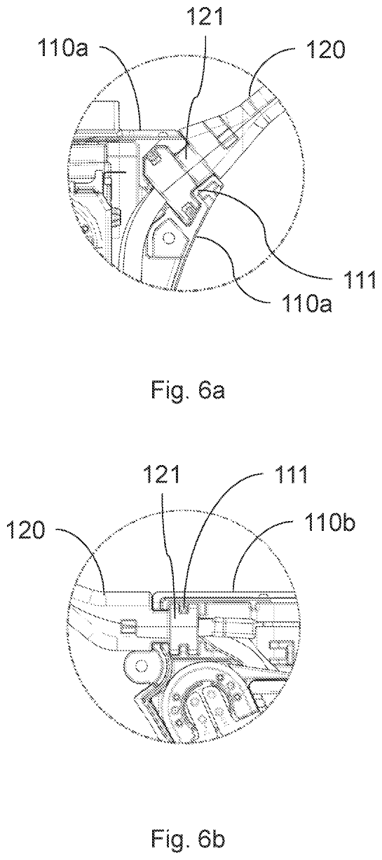

FIGS. 6a and 6b show details of the link strap 120 of the battery unit 100 of FIG. 2. When the battery unit 100 is separated from the rest of the device 10, it is not unlikely that the user will lift or carry it by holding one of the two enclosures 110a, 110b, leaving the battery cells 131 containing other enclosure 110b, 110a dangling on the link strap 120. If all that that weight is to be carried by the connections of the data wires 123 and the power cable 122 connected to the circuit boards, the connections may be damaged or break. To avoid this happening, a sufficiently rigid outer shell of the link strap 120 comprises some enclosure engaging features 121 that provide a strong connection to the enclosure 110a, 110b. The enclosures may for this purpose comprise some cooperating engagement features 111 to ensure the strong connection. This way, a dangling battery cell enclosure 110a, 110b will not apply any substantial forces to the data wire 123 or power cable 122 to circuit board connections.

FIG. 7 shows an electrical diagram of a possible way to electrically connect the battery cells 131 in the battery unit of FIG. 2. The battery unit 100 in this example comprises 12 battery cells 131, six for each enclosure 110a, 110b. Within an enclosure 110a, 110b, pairs of battery cells 131 are connected in parallel and three of such parallel pairs are connected in series. A first one of these three pairs is connected, via the circuit board, to the charge and discharge cables 31, 32 that lead to other parts of the vacuum cleaner 10. The last one of these three pairs is connected to a first one of the battery cell pairs in the other enclosure 110b, 110a. This connection is provided by the power cable 122 in the link strap 120, which will usually also be connected to the battery cells 131 via the respective circuit boards. In the other enclosure 110b, 110a, the last pair of battery cells 131 is connected, via the circuit board, to the charge and discharge cables 31, 32 that lead to other parts of the vacuum cleaner 10.

In this example, cell parameters such as temperature and state of charge are measured per pair of battery cells 131. Suitable measurement electronics such as the temperature sensors 141 of FIG. provide these measurements. Some processing of these measurements may occur in the portion of the battery management electronics 140a, 140b in the same enclosure, thereby enabling a quick response to, e.g., a sudden increase in battery cell temperature. Such functionality will thus be provided in both enclosures 110a, 110b. Other, generally higher level, processing of the information may occur in the battery management electronics 140a, 140b at one of the two enclosures 110a, 110b only. For enabling such data processing, which requires measurement data concerning battery cells 131 in both enclosures 110a, 110b, a data wire 132 in the link strap 120 enables the necessary data communication. As a result, the lower level data processing may continue when the link strap 120 is mechanically damaged and data transport between the two enclosures 110a, 110b is hampered. This is especially important for safety related battery management functionality that only requires the input of measured battery cell parameters of individual battery cells 131 or pairs of battery cells 131. Battery management control functionality that requires input from all the twelve battery cells 131 can be provided by control electronics in one enclosure only, thereby avoiding the need to provide such control electronics in both enclosures.

1. A vacuum cleaner for cleaning a surface, the vacuum cleaner comprising a battery unit for powering the vacuum cleaner, the battery unit comprising:
a plurality of serially connected battery cells;
battery management electronics operatively coupled to the battery cells;
a link strap interconnecting the portions of the battery management electronics; and
two enclosures provided on either side of a central axis of the vacuum cleaner, each enclosure comprising:
a portion of the plurality of battery cells, and
a portion of the battery management electronics operatively coupled to the respective portion of the plurality of the battery cells.

2. The vacuum cleaner as claimed in claim 1, wherein the battery management electronics are configured to supply power and convey data through the link strap.

3. The vacuum cleaner as claimed in claim 1, wherein each portion of the battery management electronics comprises at least one temperature sensor for measuring a temperature of at least one of the battery cells in the respective enclosure.

4. The vacuum cleaner as claimed in claim 3, wherein each portion of the battery management electronics further comprises a thermal protection circuit, operatively coupled to the at least one temperature sensor and configured to prevent overheating of at least one of the battery cells.

5. The vacuum cleaner as claimed in claim 1, wherein each portion of the battery management electronics comprises at least one fuse or a charger connection detection circuit.

6. The vacuum cleaner as claimed in claim 1, wherein the portion of the battery management electronics in a first one of the two enclosures is part of a master module and the portion of the battery management electronics in a second one of the two enclosures is part of a slave module and wherein only the master module comprises a data connector for enabling a direct data connection to a vacuum cleaner control unit that is not part of the battery unit.

7. The vacuum cleaner as claimed in claim 1, wherein the two enclosures are provided substantially symmetrically on either side of the central axis.

8. The vacuum cleaner as claimed in claim 1, wherein the two enclosures comprise an equal number of the battery cells.

9. The vacuum cleaner as claimed in claim 1, wherein the two enclosures comprise battery cells of the same type.

10. The vacuum cleaner as claimed in claim 1, wherein the battery unit comprises more than two enclosures, each enclosure comprising a portion of the plurality of battery cells and a portion of the battery management electronics operatively coupled to the portion of the plurality of the battery cells, the battery unit further comprising at least one additional link strap interconnecting the portions of the battery management electronics comprised in two of the more than two enclosures.

11. The vacuum cleaner as claimed in claim 1, wherein the vacuum cleaner is an autonomous robotic vacuum cleaner.

12. The vacuum cleaner as claimed in claim 11, further comprising a rotatable brush bar for agitating the floor surface, wherein the central axis of the vacuum cleaner is defined as a line crossing a geometric centre of the brush bar and of the vacuum cleaner.

13. The vacuum cleaner as claimed in claim 12, further comprising at least three support members, such as wheels and/or tracks, for supporting the vacuum cleaner on a floor surface, and wherein the enclosures are positioned in such a way that a centre of mass of the vacuum cleaner is located in a central position between the support members.

14. The vacuum cleaner as claimed in claim 11, wherein one of the enclosures further comprises an exhaust for releasing cleaned air from a main working airflow of the vacuum cleaner.
